(19) United States
(12) Patent Application Publication
(10) Pub. No.: US 2015/0223918 A1
(43) Pub. Date: Aug. 13, 2015

(54) DENTAL PASTE DISPENSER AND METHOD OF USE

(71) Applicant: Anoop S. Bawa, Gainesville, VA (US)

(72) Inventor: Anoop S. Bawa, Gainesville, VA (US)

(21) Appl. No.: 14/617,952

(22) Filed: Feb. 10, 2015

Related U.S. Application Data
(60) Provisional application No. 61/938,679, filed on Feb. 11, 2014.

(51) Int. Cl. A61C 17/02; A61C 1/00

(52) U.S. Cl. CPC A61C 17/0202; A61C 1/0084

(57) ABSTRACT

A dental polish paste dispensing device that simply dispenses pastes more quickly, easily and efficiently. The dispensing device is comprised of a pair of securing rings and a central portion with a paste container, plunger and body portion. Two fingers are placed through the securing rings until the device is securely held in a clinician's hand. The container is filled with the substance to be dispensed such as a prophylaxis polishing paste. The container and the securing rings are secured together by the body section. The paste is pushed along, moving moved conveniently and gradually from the bottom of the container outward, saving the clinician the time and extra effort.

### CROSS REFERENCE TO RELATED APPLICATION(S)

This application claims the benefit of U.S. Provisional Application No. 61/938,679 entitled “DENTAL PASTE DISPENSER AND METHOD OF USE,” filed on Feb. 11, 2014, the subject matter of which is hereby incorporated therein by reference in its entirety.

### TECHNICAL FIELD OF THE INVENTION

The present invention relates to the general art of dental equipment.

### BACKGROUND OF THE INVENTION

Operations wherein a material is applied to a tooth or teeth, most often teeth cleanings, are typically performed by dentists, dental assistants or dental hygienists. Typically, a small disposable plastic cup, with a circumference of around 15-20 mm, or roughly the circumference of a dime, is filled with a substance to be dispensed, usually a prophylaxis teeth cleaning paste. The cup of paste is held between two fingers and the clinician dips a prophylaxis hand piece or prophylaxis brush into the cup and coats the end with the paste. The paste is applied with the brush to the patient's teeth. This is done over and over again until the patient's teeth are cleaned or whatever procedure is being conducted is completed.

This method is inefficient and unsatisfactory in a number of ways. Because of the small size and lightness of the disposable cup, it is challenging to get the prophylaxis brush into the cup. The cup can be difficult to place the brush within, particularly if the clinician is holding the paste and moving around. The cup is also prone to tipping because it is light, so must be held firmly when the brush is placed within. This situation is made more difficult as the procedure progresses because as the paste within the cup is reduced, the need for the clinician to move the brush and “dig around” to obtain paste on the brush increases, which increases the time involved and difficulty in balancing the cup.

One solution is to dispense the paste from a larger, but less portable container. However, larger containers arc harder to hold, particularly while the clinician has to hold and use the brush at the same time, so such containers usually have to be placed on a flat surface. When this is done, the clinician must stop every time more paste is needed and move the brush to the surface where the paste cup is. This takes more time and is less convenient. Because teeth cleaning or other application procedures cal for movement, it is beneficial for a clinician to be able to move around freely while using the prophylaxis brush, while still having constant access to the paste. Further, as the amount of paste within the cup goes down, the clinician is eventually forced to hold the cup, to keep it from moving around as the clinician moves the brush within the container to obtain the final portion of paste. This increases the time and reduces the efficiency for any procedure.

Therefore, there is a need for a simple and more functional device for dispensing prophylaxis dental polishing paste. or any other beneficial substance. that allows a clinician to obtain the paste onto the brush in a more satisfactory manner, and more easily hold and balance the paste cup, while offering the clinician freedom of movement while doing so.

### SUMMARY

These and other objects are achieved by a dental polish paste dispensing device that simply dispenses pastes more quickly, easily and efficiently. The dispensing device is comprised of a pair of securing rings and a central portion with a paste container, plunger and body portion.

Two fingers are placed through the securing, rings until the device is securely held in a clinician's hand. The container is filled with the substance to be dispensed, such as a prophylaxis polishing paste for cleaning teeth. The container and the securing rings are secured together by the body section and a plunger is seated within a hollow opening of the body section. The clinician presses the base of the plunger upward with a thumb, pushing the paste along. In this manner, the paste is moved conveniently and gradually from the bottom of the container outward, thereby saving the clinician the time and extra effort of having to dig or pull the paste at the bottom of the cup out.

### BRIEF DESCRIPTION OF THE DRAWINGS

FIG. 1 is a partially cut-away frontal perspective view of an embodiment of the present invention.

FIG. 2 is a top plan view of the embodiment shown in FIG. 1.

FIG. 3 is a frontal perspective view of an embodiment of the present invention.

### DETAILED DESCRIPTION OF PREFERRED EMBODIMENTS

Other objects, features and advantages of the invention will become apparent from a consideration of the following detailed description and the accompanying drawings. The following descriptions are made referring, to the figures, wherein like reference number refer to like features throughout this description.

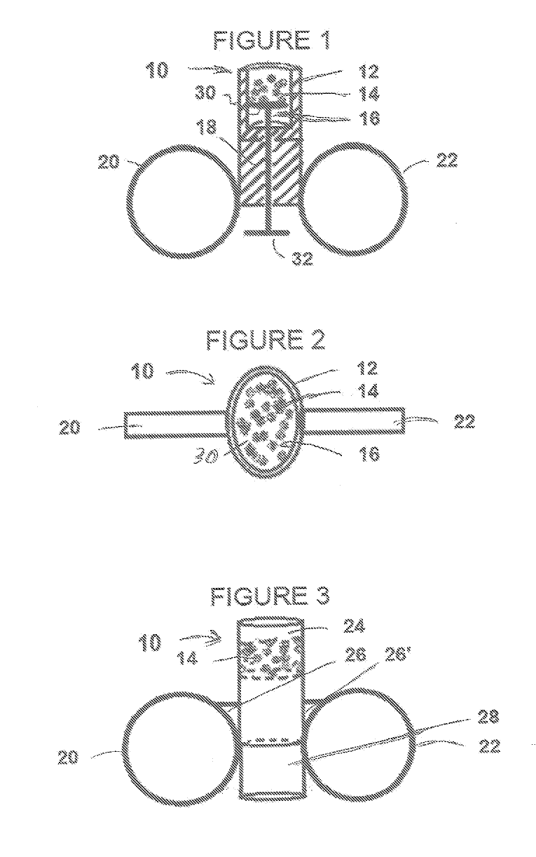

One exemplary embodiment of the present invention is shown in FIGS. 1-2. Turning to FIG. 1, a dental paste dispenser 10 is shown that can be used to simply and easily help dispense pastes more quickly, easily and efficiently. The dispensing device 10 is comprised, generally. of a central portion, which includes a paste container 12, plunger 16 and body portion 18, and a pair of securing rings 20, 22.

Two fingers, typically the index and middle fingers, are placed through the securing rings 20, 22 until the device is securely held in a clinician's hand. Turning specifically to FIG. 1, the figure is cut away so that the interior of the dispenser 10 can be viewed. The container 12 is filled with the substance to be dispensed 14. The container 12 can be any suitable shape, such as circular, elliptical, oval or rectangular. In this embodiment, the container 12 is round with a circular bottom and is in basically the shape and configuration of a cup.

Typically, the substance is a paste and as in this embodiment, is a prophylaxis polishing paste for cleaning teeth. Utilizing the pair of securing rings 20, 22, the clinician is able to easily secure the device in one hand while obtaining paste with a polishing brush or other suitable implement (not shown) with the other hand. The brush is coated with the paste 14 to be applied to a patient's teeth. The container 12 and the rings 20, 22 are secured together by the body section 18. The body section 18 is hollow, with an opening extending from the bottom of the paste cup 12 to the bottom of the body section 18. A plunger 12 is seated within this opening. The plunger can be of any suitable type or configuration known in the art for moving a substance along. In this embodiment the plunger 12 is roughly in the shape of a sideways “H” with a base 32 at the bottom and platform 30 at the top. As indicated by arrows in FIG. 1 at the bottom of the device 10, when the clinician presses the base 32 of the plunger 12 upward, the plunger platform 30 moves correspondingly, pushing the paste 14 upward. In this manner the paste is moved conveniently and gradually from the bottom of the container 12 outward by simply applying the appropriate pressure to the plunger 16, typically with a thumb. Rather than have to reach in and dig for the paste as the clinician nears the bottom of the cup 12, the clinician gradually empties the paste cup 12 by moving the paste upward

Turning to several components of the invention, it is to be understood that the dispenser 10, and the individual parts of the dispenser 10, can be comprised of any suitable material in the art, including, but not limited to, any suitable type of plastic or resin, silicone, glass, sterilizable metal, wood, rubber or rubberized material or any combination of these. The dispenser 10 can be comprised, other than the plunger 18, of a single piece construction, with the plunger 16 assembled and/or added by means known in the art. In this embodiment, the dispenser 10 is a single-piece construction molded plastic, and the plunger 16 is comprised of plastic as well. If the dispenser 10 is comprised of multiple parts, the can be secured to each other by any suitable means known in the art, including high-strength adhesive, resin, screws or rivets.

The container 12 can be of any suitable size, depending on the material to be dispensed, procedure to be performed and other conditions, though the size is limited by the placement of the body 18 between two fingers that are in the rings 20, 22, and the container 12 either in between or atop the rings 20, 22. The circumference of the inner wall of the container 12 can be generally from about 10 mm up to about 200 mm. In this embodiment, the cup is between 15 and 20 mm and preferably about 18 mm.

Turning briefly to FIG. 2, The platform 30 of the plunger 16 can be seated against inner the wall of the container 12 by any suitable means. It can be of a circumference slightly smaller than that of the inner wall of the container 12, such as 0.001 mm to 5 mm less, and stay secured to the wall of the container 12 through friction. The plunger platform 30 can also be seated against the container 12 wall by a lip around the edge of the platform 30 comprised of any suitable material in the art, including, but not limited to, a soft plastic, foam, rubber or rubberized material or a silicone.

The rings 20, 22 can be rigid and of a circumference suitable for fitting on most fingers, as in this embodiment, or can be more flexible and adjustable to different-sized fingers by any suitable means in the art, such as a series of holes and pins or comprised of a pair of adjustable slideable arms (not depicted).

Turning to FIG. 3, an alternative embodiment of the invention is depicted. In this embodiment, a dispensing tube 24 and a piston type plunger 28 are in a coaxial arrangement, with the piston plunger 28 within the dispensing tube 24. Paste 14 is placed in the dispensing tube. The top of the piston plunger 28 forms the bottom wall of the dispensing tube 24. The piston plunger is pressed from below 28, as in the previous embodiment, and the paste 14 pushed upward, for easy and convenient access by the clinician. The piston plunger can be secured within the inner wall of the dispensing tube by any suitable means, including those noted herein for securing the plunger 12 within the container 12.

The dispensing tube 24 can be secured to the rings 20, 22 by a single body piece that attaches the tube 24 and respective rings 20, 22 or, as in this ere by a pair of body pieces 26, 26′ extending from each side of the tube 24 to each of the respective rings 20, 21

In yet another embodiment, the dental paste dispenser 10 is comprised so as to be a single-use disposable device. The dispenser 10, could be made mostly or entirely of plastic, for example. The container 12 is pre-filled with the substance to be dispensed 14. When the clinician or other user is finished with the dispenser 10, it is simply discarded. This eliminates the need for the clinician or other user to repeatedly fill the dispenser. It also eliminates concerns about sterilization of the dispenser between uses. Both of these together save the clinician or other user time and effort.

By this simple method and device, a clinician can more easily and efficiently dispense dental polishing paste to a patient. It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A dental polish paste dispensing device comprised of:
a pair of securing rings and a central portion located between the pair of securing rings and attached to the pair of securing rings,
wherein the central portion is further comprised of a body portion and a plunger situated within the body portion such that the body portion and plunger are in a coaxial relationship to each other.
